(19) United States
(12) Patent Application Publication
(10) Pub. No.: US 2024/0341022 A1
(43) Pub. Date: Oct. 10, 2024

(54) REMOTE MANAGEMENT FRAMEWORK IN SENSOR AND ACTUATOR NETWORK

(71) Applicant: Schreder S.A., Bruxelles (BE)

(72) Inventors: Sérgio CARVALHOSA, Carnaxide (PT); Pedro CARREIRA, Carnaxide (PT)

(21) Appl. No.: 18/579,751

(22) PCT Filed: Jul. 20, 2022
(86) PCT No.: PCT/EP2022/070429

§ 371 Date: Jan. 16, 2024

(30) Foreign Application Priority Data
Jul. 20, 2021 (NL) 2028792

(51) Int. Cl. H05B 47/115; H04L 67/12

(52) U.S. Cl. CPC H05B 47/115; H04L 67/12

(57) ABSTRACT

A method of controlling an actuator in a sensor and actuator network comprising a first physical sensor at a first node and an actuator at a second node, comprising: associating the first physical sensor to a sensor group: defining the first physical sensor as a publisher for publishing a first state in the sensor group, being based on data sensed by the first physical sensor, from said first node to at least said second node. The method further comprises: creating a virtual sensor having a state at the second node and associating the virtual sensor to the sensor group, defining the virtual sensor as a subscriber for receiving the first state as its state, and controlling the actuator based on the virtual sensor state: or, determining a group state of the sensor group based on the first state, and controlling the actuator based on the group state.

### FIELD OF INVENTION

The field of invention relates to sensor and actuator network control methods, sensor and actuator networks, and controllers, especially luminaire controllers, for use in sensor and actuator networks. Particular embodiments relate to management of sensed data for remote control of actuators in a network, especially a luminaire network.

### BACKGROUND

Nowadays, there is a growing interest in technologies for the development of smart cities. This development relies on the easy circulation of information within the smart cities to enable various kinds of control strategies. Smart cities are also integrating a large number of sensors, e.g. cameras, pollution sensor, sound sensors, in order to gather information and enable quick reaction in case of problems occurring, for example. Usually, luminaires provide an advantageous support for these sensors since they are readily present throughout streets and present valuable vantage points. Taking advantage of the sensors in smart cities and the information gathered to remotely activate actuators in function would be desirable in order to further increase the development of smart cities.

In prior art solutions, to address the above mentioned problem, information would be centralized in a remote control server before being processed and control commands emitted towards predetermined actuators. However, centralization presents its own limitations in terms of information management. This is especially true as the amount of information to be transmitted and processed becomes increasingly large. There is thus a need to overcome the problems posed by a centralization management scheme when remotely controlling actuators.

### SUMMARY

The object of embodiments of the invention is to provide a sensor and actuator network control which allows for flexible management of sensed data for remote activation of actuators while targeting sensed data relevant for these actuators in order to avoid less important communication.

According to a first aspect of the invention, there is provided a method of controlling an actuator in a sensor and actuator network. The sensor and actuator network comprises a first physical sensor at a first node and an actuator at a second node. The method comprises the steps of:
associating at least the first physical sensor to a sensor group;
defining the first physical sensor as a publisher for publishing a first state of the first physical sensor in the sensor group, said first state being based on data sensed by the first physical sensor, said publishing comprising transmitting said first state from said first node to at least said second node; and
at least one of:
   creating, at the second node, a virtual sensor having a state, associating the virtual sensor to the sensor group; defining the virtual sensor as a subscriber for receiving the first state as the state of the virtual sensor; and controlling the actuator based on the state of the virtual sensor;
   determining a group state of the sensor group at least based on the first state; and controlling the actuator based on the group state.

By having a sensor group, i.e. a type of logical construct, one can obtain, among other things, a communication tool which is replicated at the first and at the at least second node. This allows for information to be propagated easily from one node to another node where the sensor group exists. In the present case, information which would be relevant for the actuator at the second node is published by the first physical sensor in the sensor group. By publishing, it is meant that the first state which is captured by the first physical sensor is broadcasted by the first node, for example, to be then received, and optionally processed, at the second node via the sensor group. Note that the broadcasting is not limited to only two nodes, but to every node where the sensor group has been created.

Additionally, the skilled person will understand that the publishing in the above is not limited to a broadcast-type of communication but could be implemented using other wired or wireless communication technologies between nodes without departing from the scope of the invention. Communication technologies used by outdoor lighting networks, for example, include ZigBee, WiFi, cellular (GPRS, 3G/4G/5G), and power line communication networks, which normally have limited bandwidth.

At the second node, the virtual sensor is defined as a subscriber in the sensor group. That is, the virtual sensor will receive the sensed data published in the sensor group and broadcasted between nodes, e.g. between the first node and the at least second node. The state of the virtual sensor will become the received sensed data, here the first state. So, the first physical sensor at the first node will be cloned at the at least second node, and in this way the first state of the first physical sensor can be used at the at least second node to control the actuator. The creation at the second node of the virtual sensor, which is a type of remote sensor construct, enables targeted propagation of information for a relevant use.

Alternatively or additionally, the group state is determined for the sensor group. In this case, the sensor group takes the first state as an input to determine the group state and a processing of this input may occur. The processing may take the form of an operation applied to the input. The output of the operation if any, i.e. the group state, may serve to control the actuator. Using the group state for controlling the actuator enables processed data to be used at a remote location. In an alternative embodiment, the group state may be used as an input for further processing in another sensor group.

In an embodiment, the processing may be performed only at the node where the actuator is physically located and lessens the burden on the rest of the network. It is to be noted that the actuator and sensor network may comprise other nodes in addition to the first node and the second node. According to another embodiment, the processing may be divided between the nodes in the network depending on a processing power of each node, e.g. with the amount of processing performed by each node being proportional to the processing power of said node. According to an alternative embodiment, the processing may be performed at another node part of the network different from the node where the actuator is physically located, e.g. at the first node or a further node.

In the above, by controlling the actuator, it is meant modifying an actuation profile of the actuator. The actuation profile can include simply the switching of the actuator between an off state and an on state, or may involve a more complex control with a modification of a frequency or an intensity of the actuation, for example, as well as other functioning parameters of the actuator. By actuator, it is meant a mechanism that supplies and transmits a measured amount of energy for the operation of another device or system.

Depending on embodiments, the actuator of the sensor and actuator network may be to supply and transmit energy to any one or more of the following devices: a lighting device, a display device, an antenna device, a sensor, a speaker device, an air cleaning device such as a UV light source, a water sprinkler, a power relay, a motorized device, a communication device. Also, a sensor of the sensor and actuator network may be any one of: a metering device in a node, a pollution sensor, a motion sensor, a humidity sensor, a light sensor, a temperature sensor, a visibility sensor, an image capturing sensor, a radar sensor, a sound sensor, a voice recorder, a CO2 sensor, a NOx sensor, a SOx sensor, a smoke sensor, a biological threat sensor, an infrared sensor, a thermal sensor, an antenna, e.g. an antenna for RF sensing, a vibration sensor.

According to a preferred embodiment, the sensor and actuator network further comprises a second physical sensor. The method further comprises the steps of:
associating the second physical sensor to the sensor group;
defining the second physical sensor as a publisher for publishing a second state of the second physical sensor in the sensor group, said second state being based on data sensed by the second physical sensor;
determining the group state of the sensor group based on the first state and the second state.

In this manner, the sensor group may be used such that multiple inputs are taken into account when controlling the actuator. The first and second physical sensors may be similar or may be different. The first and second physical sensors may be located at the same node or at different nodes. For example, the second physical sensor may be located at the second node or at a third node different from the first and second nodes.

Fusing the first state and the second state may further allow for higher level of states in terms of information to be derived. Additionally, fusing the first and second states may be useful in combining data obtained from sensors of different types and/or location in order to consolidate and/or improve accuracy of the information derived from said data. For example, the first physical sensor may be a presence sensor and the first state indicate the presence of an incoming vehicle, the second physical sensor may be an infrared sensor and the second state indicate the temperature sensed in its field of view; combining the first state and the second state, the group state may indicate what type of vehicle is incoming. The skilled person will understand that many operations on states are available and possible to implement based on the above described method.

Depending on embodiments, processing of the inputs in the sensor and actuator network can take different shapes and processing architectures including, but not limited to, cloud computing, edge computing, fog computing.

It is common practice today to use Cloud Computing architecture approaches between sensors and actuators deployed in smart cities, limiting the free flow of information between devices due to the centralistic nature of the architecture. To unlock the potential of the generated data, new architectures are discussed in literature. One approach to address the explosion of the Internet of Things (IoT) and the ability to collect, analyze and provide big data in the cloud is edge computing; a new computing paradigm in which data is processed at the edges, i.e. at the sensor's level.

Edge Computing refers to the approach to push the process of knowledge discovery from the cloud further towards the connected end devices, also called IoT devices or edge devices. Edge computing provides shorter response times, reduces bandwidth costs, and increases data safety and privacy protection when compared to cloud computing.

In an embodiment, the actuator and sensor network may comprise a plurality of edge devices, optionally a plurality of fog devices, and a central control system. The plurality of edge devices is arranged at a plurality of locations. An edge device thereof comprises at least one data source, such as a sensor, e.g. the first physical sensor, an edge processing means, e.g. the first or the second controller, and an edge communication means. The at least one data source may be configured to obtain environmental data, said environmental data being related to an event in the vicinity of the edge device or in the edge device. The edge processing means may be configured to produce edge processed data based on said environmental data. Optionally, the edge processed data may comprise at least one value representative for a class selected from a plurality of predetermined classes for classifying the event. The edge communication means is configured for communicating raw data directly obtained from the data source and/or edge processed data. The edge devices may communicate directly with the central control system and/or with a fog device.

A fog device of the plurality of fog devices may be associated with a subset of the plurality of edge devices. The fog device comprises a fog communication means and a fog processing means. The fog communication means is configured to receive raw data and/or edge processed data from said subset and to transmit fog processed data. The fog processing means is configured to process the data received from said subset and to produce fog processed data based thereon. The fog processed data may comprise information about an event in the vicinity of the subset or an event in at least one edge device of the subset. The central control system is in communication with the plurality of fog devices and configured to receive fog processed data from said plurality of fog devices.

In this way, the actuator and sensor network using fog devices and/or some preprocessing in the edge devices provides a good trade-off between pure edge computing and computing in the central control system, typically the cloud. More in particular, by determining a value representative for a class of an event in the edge device or in the vicinity of the edge device, the obtained environmental data can be transmitted in a more compact and sustainable manner to the associated fog device. Also, because the fog device may obtain edge processed data from a subset of edge devices, it can produce fog processed data about an event in the vicinity of the subset, where possibly more than one edge device has classified that event and transmitted edge processed data about that event to the fog device. In that manner, the fog device is capable of generating fog processed data about the event which is more accurate and/or more compact and/or more complete than the sum of the edge processed data received from the subset. In other words, the solution fog/edge computing can bridge the gap between the central control system and the data sources of the edge devices by suitably organizing computing, storage, networking, and data management between the edges devices, the fog devices and the central control system. The benefit of this solution is that the environmental data can be processed partially locally in the edge devices and partially regionally in the fog devices, reducing the amount of data that has to be transmitted to the central control system, the amount of processing in the central control system and thus the latency for processing the data. Also, privacy related data may be processed locally or regionally, wherein a decision may be taken locally or regionally as to whether that data should be sent to the central control system, typically the cloud. In this way privacy is insured and sustainable data is processed by design. Thus, this architecture favors data minimization and data protection since only selected parts of the data will travel in selected parts of the upward edge-fog-cloud chain. Such an architecture has been described in WO2022/122750 A1 in the name of the applicant, which is included herein by reference. Using fog computing architecture in an embodiment of the present invention allows for an optimization of data processing, in particular when determining the group states of the sensor groups.

EP3725135 A1 in the name of the applicant, which is included herein by reference, describes a luminaire network comprising a plurality of luminaires as well as a central unit, and comprising a central communication unit. A plurality of luminaires in the network comprises a communication unit configured to make it possible for the luminaires to communicate with each other and/or with the central communication unit, as well as a control unit configured to control the luminaire as well as the communication unit. Embodiments of the present invention can take advantage of the communication possibilities described as well as the collaboration presented between the luminaires, in particular the distribution of the processing between the central unit and the luminaire processing units, in order to communicate the states of the various sensors and sensor groups and to process the data in the actuator and sensor network.

WO20191/75435 A2 in the name of the applicant, which is included herein by reference, describes a luminaire network wherein the processing unit of the luminaire is configured to process the first sensed data to produce first processed data; and wherein the luminaire network is further configured such that the first processed data of at least two luminaires is further processed to produce second processed data. Embodiments of the present invention can take advantage of the combining of data described to implement, in an embodiment, sensor groups having group states with a higher data quality due to the combination of states from multiple sensors with some overlapping in what they measure, and whose group states would not be otherwise achievable by measurements performed by a single sensor.

WO2022/122755 A1 in the name of the applicant, which is included herein by reference, describes a system comprising at least a first sensor and a second sensor arranged at one or more edge devices, a first processing means and a second processing means, and a control means configured to control the first and second processing means such as to train the first processing means based on data processed by the second processing means. Embodiments of the present invention can take advantage of the training described to further reduce the processing burden in the overall actuator and sensor network and improve the processing. Indeed, in embodiments of the invention states from one or more sensors may be used and these one or more states may subject to an operation using a model, to determine a group state of the sensor group. According to a possible embodiment, a model may be used for the operation to determine a group state based on at least one sensor state, and this model may be used for training another model to determine another group state based on at least one other sensor state.

PCT/EP2022/056270 in the name of the applicant, which is included herein by reference. describes a network system comprising a plurality of edge devices arranged at a plurality of locations, the plurality of edge devices comprising at least a sensor and a processing means. The network system is configured to determine an updated model over time used to process input data and to reset the processing means so as to process input data in accordance with the updated model. Embodiments of the present invention may updating a processing model to determine a state of a sensor. Over time, parameters of the sensors, e.g. the first physical sensor, in the actuator and sensor network may be changed to improve the operation of the sensors. Additionally, a model used to process the one or more sensor states to determine a sensor group state can be regularly updated to improve its quality.

NL2028884 in the name of the applicant, which is included herein by reference, describes an edge device configuration system for setting an initial configuration of edge devices and/or for updating a configuration over time, each edge device comprising sensors and a processing means, the edge device configuration system comprising a control means configured to configure each respective edge device based on a data model selected to correspond to obtained environmental parameters. Embodiments of the present invention can take advantage of the automatic configuration described. Indeed, in embodiments of the invention sensor groups may be defined each associated with a corresponding physical sensor and a group state thereof may be processed using a data model automatically configured using configuration parameters of the physical sensors and/or processing models particularly adapted to an environment of the corresponding physical sensor.

NL2031012 in the name of the applicant, which is included herein by reference, describes a system for determination of traffic flow information in an area comprising a traffic surface comprising, a sensing means and a processing means such as to allow determination of traffic flow information related to moving objects on area comprising the traffic surface. Embodiments of the present invention can take advantage of the traffic flow information determination described by setting up a sensor group whose group state is determined using a model based also on external data. Indeed, by using external data, e.g. a map of the area, a layout of the area, etc., in addition to states of physical sensors, and by processing the group state with an appropriate model, the group state can give traffic flow information with greater accuracy.

According to an exemplary embodiment, the actuator and sensor network may comprise multiple sensors, e.g. an optical sensor such as a photodetector or an image sensor, a sound sensor, and a radar such as a Doppler effect radar.

In a fog computing architecture as presented above, for example, an edge device of the actuator and sensor network may correspond to the multiple sensors, e.g. an optical sensor such as a photodetector or an image sensor, a sound sensor, and a radar such as a Doppler effect radar. Such an exemplary combination of sensors is both practical and efficient mimicking the human senses of touch, hearing and sight. Preferably, the optical sensor is an image sensor such as a camera. It has been found that the combination of these three sensors in an edge device allows for an accurate classification of objects in the vicinity of the edge device, at all times of the day. Such classification may be used to update a model used to determine the group state of a sensor group, either at the edge device or in a remote device.

The skilled person will understand that implementation of the combination of these three sensors is not limited to a fog computing architecture and can be implemented in equally beneficial manners to other computing architectures of the actuator and sensor network.

Additionally, the sensor group may be associated to another sensor group. The sensor group may be defined as a publisher for publishing the group state of the sensor group in the another sensor group. Another group state of the another sensor group may be defined based at least on the group state. So, group states of sensor groups may also be used as inputs of other sensor groups in order to derive group states representing higher levels of information, thereby making a “chain” of sensor groups.

It is to be noted that this ability to “chain” sensor groups also allows distributing processing load across different nodes in the sensor and actuator network. For example, nodes with substantially high processing capabilities can be configured with sensor groups whose aim is to collect one or more sensor states as inputs, process the inputs based on fusing algorithms, and send the resulting output to another sensor group. Actuators at nodes with lower processing capabilities can then subscribe to the another sensor group and perform control of said actuators based on the resulting output published to the another sensor group by a sensor group of the sensor groups whose group states have been processed by the nodes with substantially high processing capabilities.

According to an exemplary embodiment, the first node, the second node, and any other node with a physical sensor and/or virtual sensor and/or actuator associated to the sensor group stores information related to the sensor group, said information comprising the group state.

It is to be noted that the information stored may comprise, amongst others, any state of a physical sensor publishing in the sensor group as well as the group state, e.g. obtained by fusing one or more states obtained by the sensor group.

In this way, the group state is available at all nodes where the first state is broadcasted, and thus where the group state could potentially be relevant.

According to a preferred embodiment, the information comprises a multicast address linked to the first physical sensor and any other physical sensor and/or virtual sensor and/or actuator associated to the sensor group.

In this manner, the sensor group may be linked to the first physical sensor and any other physical sensor and/or virtual sensor and/or actuator via a logical identifier, the multicast address being used to establish communication between publishers and subscribers associated to the sensor group. Using a multicast address, unwanted communication may be prevented and clogging in the sensor and actuator network may be avoided. Additionally, scalability of the network is improved when adding physical sensors and/or actuators.

According to an exemplary embodiment, the information comprises an operation defining how the group state is determined based on at least the first state.

Preferably, the operation is any one of the following or a combination thereof: a Boolean operation, an addition, a subtraction, a multiplication, a division, a maxima operation, a minima operation, a weighted operation, a conversion operation.

In an embodiment, the operation may be defined as a separate logical construct, i.e. a data fusion construct, configured for performing data fusion based on at least the first state. The data fusion construct takes at least the first state published as an input, i.e. the first physical sensor publishes its first state to the data fusion construct. Then, the data fusion construct applies to one or more inputs the operation defining how the group state is determined. The data fusion construct is defined as a publisher in the sensor group. An output of the operation is published to the sensor group in order to obtain the group state of the sensor group.

More generally, any of the information related to the sensor group may be defined using a logical construct publishing in the sensor group.

In this way, the processed first state may be used to control the actuator. The processing may be performed at the node where the actuator is located. By using an operation, a finer control of the actuator may be achieved.

According to a preferred embodiment, the information comprises the first state and a state for any other physical sensor and/or virtual sensor associated to the sensor group.

In this manner, triggers from changes in the state of multiple sensors may be used to control actuation. This allows for remote controlling of actuators based on a complex consideration of the different states of the sensors associated to the sensor group. This complex interrelationship can now be more conveniently localized at the node where the actuator is located. Communication for the control of the actuator is thereby quickened.

Additionally or alternatively, the information comprises a sensor identifier of the first physical sensor, and, optionally, sensor identifiers of any other physical sensor and/or virtual sensor associated to the sensor group. For example, a sensor identifier may be defined as a memory pointer corresponding to the associated sensor.

According to an exemplary embodiment, the information comprises any one or more of the following information: a sensor group identifier, an application type defining a type of service provided by the sensor group, a quality of service defining transmission and/or congestion related information, a publisher communication profile defining information related to the publishing by the first physical sensor and any other sensor associated to the sensor group as a publisher.

In this way, the sensor group may be used in an improved manner for the dissemination of sensor information.

The sensor group identifier may be used as a reference for the first physical sensor and/or the virtual sensor to establish the link between them and the sensor group. For example, the sensor group identifier may be defined as a memory pointer.

The application type may be used to define the role or type of information which is outputted as the group state. The application type may be seen as a purely informative note for a user of the computer-implemented method. Depending on embodiment, the application type may be any one of: traffic monitoring/management, traffic counting, vehicle type detection, ghost driver detection, parking monitoring/management, air quality monitoring, adaptive lighting, etc.

The quality of service may be used to prioritize information coming from higher rated communication sources and enable a more efficient use of the sensor and actuator network. Generally, the quality of service is related to bandwidth (throughput), latency (delay), jitter (variance in latency), and error rate.

The publisher communication profile may be used to define communication parameters of sensors associated to the sensor group as publishers. The sensor group, as a logical construct, holds within its definition some rules that govern how states may be published to other nodes where the sensor group exists. The communication parameters may be related to, e.g. the rate of data transmitted, or the frequency of transmission. More particularly, when publishing the state of the sensor, the communication containing the state from the sensor defined as a publisher and achieved through broadcasting may be limited in its propagation by a distance counter allowing for the communication to reach only within a predetermined number of node hops, e.g. within two node hops. This allows limiting the range and the amount of data transferred within the sensor and actuator network.

According to a preferred embodiment, the first physical sensor is defined at the first node by storing the following information: the first state, a sensor identifier, a sensor group identifier of the sensor group, and optionally a further sensor group identifier of a further sensor group associated to the first physical sensor.

In one embodiment, the first physical sensor may be further defined at the first node by storing a sensor group role indicating that the first physical sensor is a publisher. Alternatively or additionally, the sensor group role indicating that the first physical sensor is a publisher is available in the information of the sensor group. Similarly, the sensor group role associated with the virtual sensor may be available in the information of the sensor group instead of the information of the virtual sensor.

In this way, the first physical sensor may be used in an improved manner for the dissemination of sensor information instead of being used for only a local purpose at the first node.

The sensor identifier may be used as a reference for the first physical sensor to establish the link between it and the sensor group to be used as an input, and/or as a reference for the virtual sensor as a subscriber. For example, a sensor identifier may be defined as a memory pointer corresponding to the associated sensor.

The sensor group role may be used to determine the relationship of the first physical sensor with the sensor group in terms of communication transmission and reception. A sensor may be any one of: publisher, subscriber, and detached. A publisher is configured for publishing the state of a sensor in the sensor group, which will be then broadcasted/transmitted to the nodes where the sensor group exists. A subscriber is configured for receiving as its state a state of a sensor it is subscribed to, via the sensor group. A detached sensor is a sensor whose transmitted data has been deemed as untruthful, e.g. due to a malfunction, and whose transmission to the sensor group is blocked temporarily.

The sensor group identifier may be used in the information of the first physical sensor as a reference, e.g. a memory pointer, to the sensor group it is associated to.

It is to be noted that a physical sensor may be associated to a plurality of sensor groups and publish its state to each of the plurality of sensor groups. As such, the first physical sensor may also be defined by a further sensor group identifier of a further sensor group associated to the first physical sensor.

According to an exemplary embodiment, the second physical sensor is of the same type as the first physical sensor.

In this manner, operation on the first state and the second state to determine the group state may be facilitated.

According to a preferred embodiment, the method further comprises the steps of:
associating the first physical sensor to a further sensor group;
defining the first physical sensor as a publisher for publishing the first state in the further sensor group;
determining a further group state of the further sensor group at least based on the first state.

In this way, sensed data from a single sensor may be easily disseminated throughout the sensor and actuator network using sensor groups associated to it wherever necessary.

In an embodiment, the group state of the sensor group and the further group state of the further sensor group are available at the same node and are used for different actuators and/or virtual sensors of that same node. In another embodiment, the group state of the sensor group and the further group state of the further sensor group are available for actuators and/or virtual sensors located at different nodes.

According to an exemplary embodiment, the sensor and actuator network further comprises a further actuator. The method further comprises at least one of:
creating a further virtual sensor having a further state, associating the further virtual sensor to the further sensor group; defining the further virtual sensor as a subscriber for receiving the first state as the further state of the further virtual sensor; and controlling the further actuator based on the further state of the further virtual sensor;
controlling the further actuator based on the further group state.

In this manner, control of multiple actuators may be managed at each node where necessary using either the further group state, or the further state. Scalability of the method is improved and easy to implement when introducing new actuators in the network.

According to a preferred embodiment, the sensor and actuator network is included in a luminaire network, preferably an outdoor luminaire network.

Preferably, the first node is located at a first luminaire of the luminaire network and the second node is located at a second luminaire of the luminaire network.

In this way, the sensor and actuator network method may be implemented in a readily available network, a luminaire network, which is more convenient due to its density in a city.

Preferably, the luminaire network is an outdoor or industrial luminaire network. By outdoor or industrial luminaire network, it is meant luminaire networks which are installed among roads, tunnels, industrial plants, stadiums, airports, harbors, rail stations, campuses, parks, cycle paths, pedestrian paths or in pedestrian zones, for example, and which can be used notably for the lighting of an outdoor area or large indoor area, such as roads and residential areas in the public domain, private parking areas and access roads to private building infrastructures, warehouses, industry halls, etc.

According to an exemplary embodiment, the sensor and actuator network is a mesh network.

In this manner, a network with easy scalability, resistant to problems, and having a great coverage can be implemented.

The advantages and features of the embodiments of the above described sensor and actuator network control method apply mutatis mutandis for embodiments of the below presented sensor and actuator network.

According to a second aspect of the invention, there is provided a sensor and actuator network. The network comprises: a first physical sensor, a first controller, a second controller, and an actuator. The first physical sensor has a first state based on data sensed by the first physical sensor, and is located at a first node. The first controller is located at the first node. The second controller is located at a second node. The actuator is located at the second node. The first controller is configured to define the first physical sensor as a publisher so that the first state is published in a sensor group. The publishing comprises transmitting said first state from said first node to at least said second node. The second controller is configured for at least one of:
creating a virtual sensor having a state, associating the virtual sensor to the sensor group; defining the virtual sensor as a subscriber so that the first state is set as the state of the virtual sensor; and controlling the actuator based on the state of the virtual sensor;
obtaining a group state of the sensor group at least based on the first state; and controlling the actuator based on the group state.

In an embodiment, the obtaining of the group state by the second controller may comprise determining the group state by the second controller. In another embodiment, the first controller may be configured for determining the group state of the sensor group at least based on the first state, and the second controller may be configured for obtaining the group state of the sensor group from the first controller. In an alternative embodiment, the sensor and actuator network may comprise a third controller located at a third node, said controller being configured for determining the group state of the sensor group at least based on the first state, and the second controller may be configured from obtaining the group state of the sensor group from the third controller.

According to a preferred embodiment, the first and second controllers are configured to perform the steps of the method as above described.

According to an exemplary embodiment, the sensor and actuator network further comprises a second physical sensor, and the first and second controllers are further configured to perform the steps of the related above described method.

According to a preferred embodiment, the sensor and actuator network further comprises a further actuator, and the first and second controllers are further configured to perform the steps of the related above described method.

According to an exemplary embodiment, the sensor and actuator network is included in a luminaire network preferably an outdoor luminaire network.

Preferably, the luminaire network utilizes the Lightweight Machine to Machine (LwM2M) protocol. The Lightweight Machine to Machine (LwM2M) protocol is an exemplary messaging layer M2M protocol in Lightweight Machine to Machine Technical Specification, last approved version 1.1.1, Open Mobile Alliance, 25 Jun. 2019. Machine to machine (M2M) can be used to describe any technology that enables networked devices to exchange information and perform actions without the manual assistance of humans. For example, a first M2M device may be a client device and a second M2M device may be a server device. The M2M client device may be configured to detect one or more values (e.g., a light intensity measured by a light sensor, a pollution level measured by a pollutant sensor, a temperature measured by a temperature sensor, etc.) and notify the M2M server device regarding the one or more values detected by the M2M client device. The M2M server device may perform one or more actions in response to the notification. The LwM2M protocol uses configuration parameters called Attributes. The role of these Attributes is to provide metadata which may communicate helpful information to the LwM2M Server, or, set up certain actions on the LwM2M client, for example easing data management. Examples of such Attributes are: “Minimum Period” (pmin) indicating the minimum time in seconds the LwM2M Client MUST wait between two notifications; “Maximum Period” (pmax) indicating the maximum time in seconds the LwM2M Client MAY wait between two notifications: “Greater Than” (gt) defining a threshold high value, etc.

WO2021/224247 A1 in the name of the applicant, which is included herein by reference, describes a method for providing notification by a client to a server allowing improving the reliability of the notifying in a dynamic and on-demand manner, and in particular allowing improving the reliability of the notifying for embodiments where the notifying is done using a messaging layer protocol capable of notifying asynchronous data in a dynamic on-demand manner.

In alternative embodiments, other protocols may be used such as uCIFI protocol, or MQTT protocol.

The advantages and features of the embodiments of the above described sensor and actuator network control method, and sensor and actuator network apply mutatis mutandis for embodiments of the below presented controller for use in a sensor and actuator network.

According to a third aspect of the invention, there is provided a controller for use in a sensor and actuator network. The controller is configured:
to define a sensor group associated with one or more physical and/or virtual sensors located in one or more nodes of the sensor and actuator network;
to define a first physical sensor of said one or more physical and/or virtual sensors as a publisher so that a first state thereof is published in the sensor group, said publishing comprising transmitting said first state from a node where the first physical sensor is located to any other node associated to the sensor group, said first state being based on data sensed by the first physical sensor;
to determine a group state of the sensor group at least based on the first state.

According to a preferred embodiment, the controller is further configured: to create a virtual sensor having a state, associating the virtual sensor to the sensor group; to define the virtual sensor as a subscriber so that the first state is set as the state of the virtual sensor; and to control the actuator based on the state of the virtual sensor.

According to an exemplary embodiment, the controller is further configured to control an actuator based on the group state.

According to a preferred embodiment, the controller is a luminaire controller.

### BRIEF DESCRIPTION OF THE FIGURES

This and other aspects of the present invention will now be described in more detail, with reference to the appended drawings showing a currently preferred embodiment of the invention. Like numbers refer to like features throughout the drawings.

FIGS. 1A-1E are schematic views of exemplary embodiments of a sensor and actuator network;

FIG. 2 is a more detailed illustration of an exemplary embodiment of a sensor and actuator network;

FIG. 3 depicts an exemplary embodiment of a sensor and actuator network included in a luminaire network.

### DESCRIPTION OF EMBODIMENTS

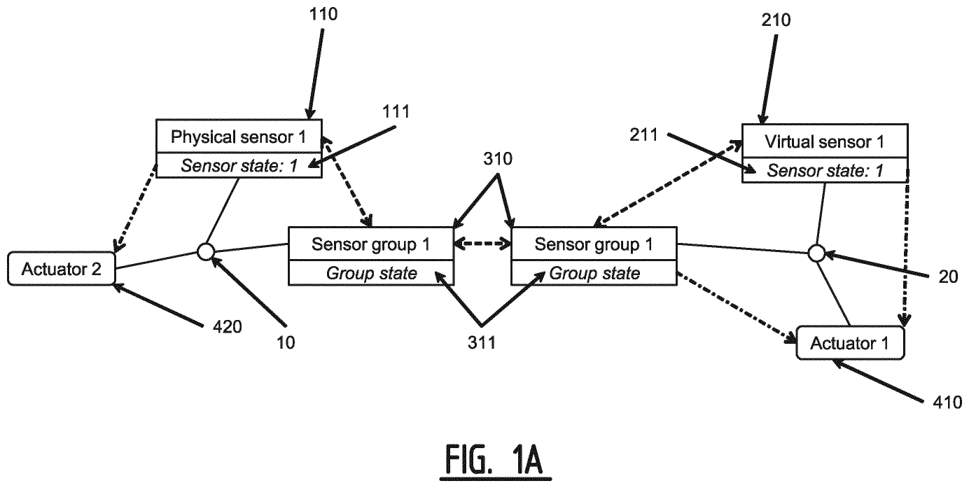

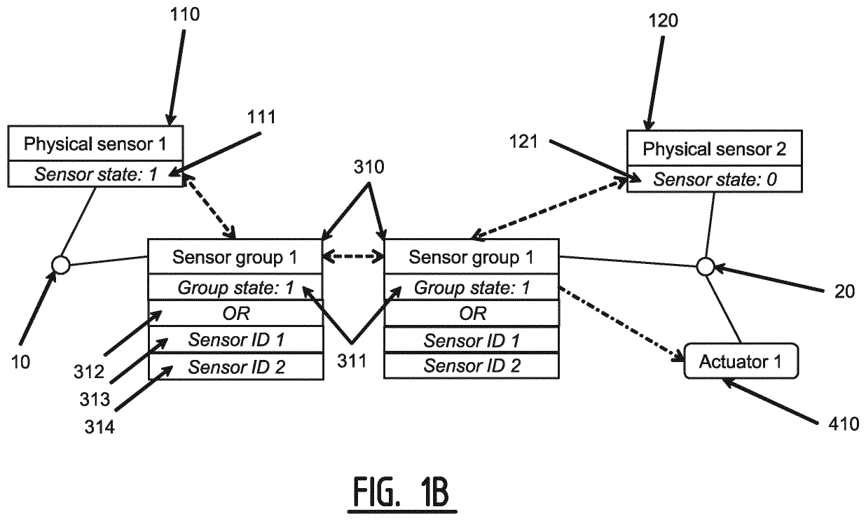

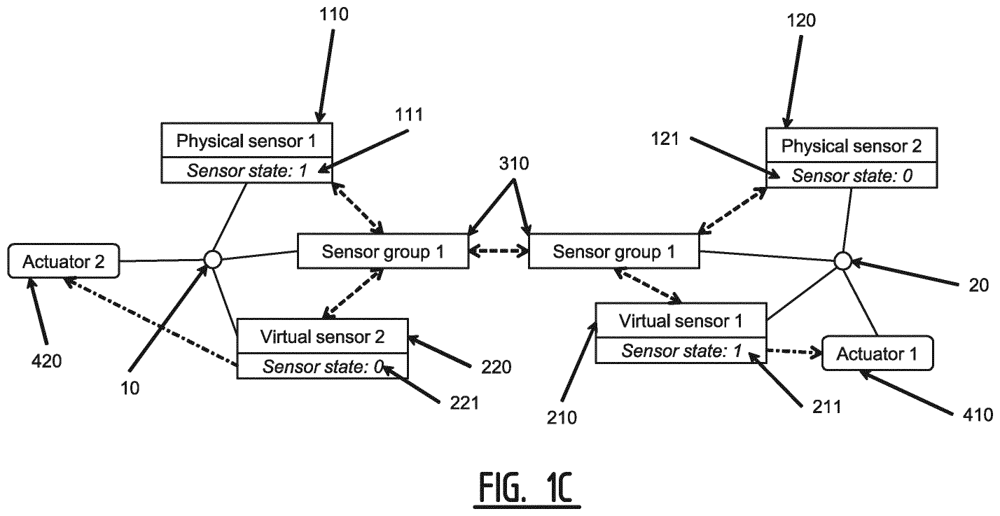

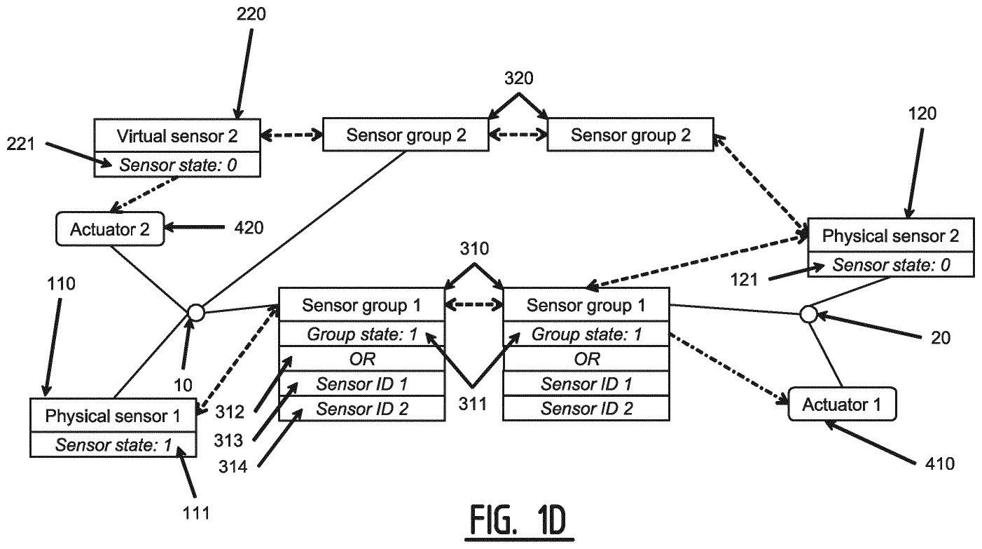

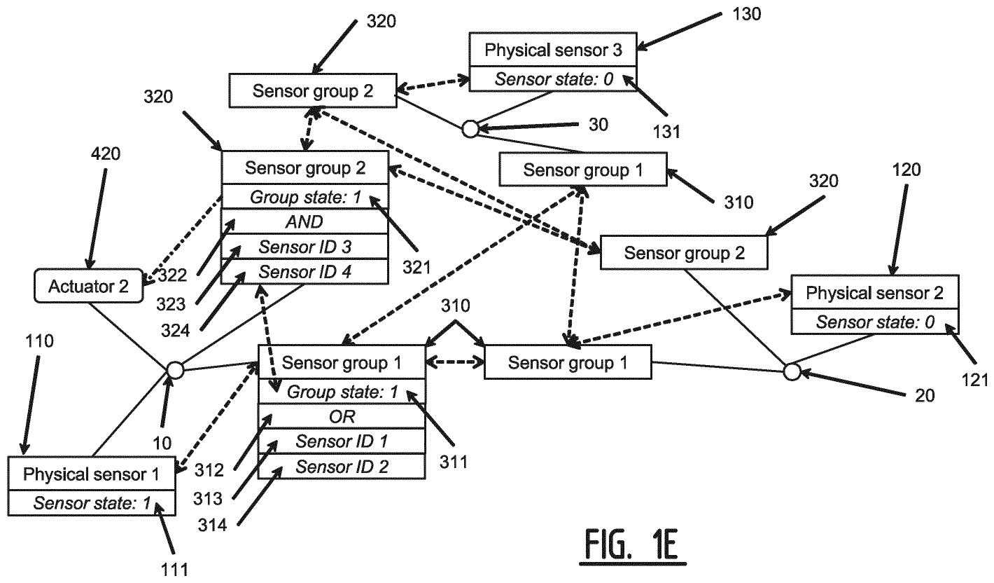

FIGS. 1A-1E are schematic view of exemplary embodiments of a sensor and actuator network according to the present invention.

The sensor and actuator network comprises a first physical sensor 110, and an actuator 410. The first physical sensor is located at a first node 10. The actuator 410 is located at a second node 20. A first controller part of the sensor and actuator network located at the first node 10, and a second controller part of the sensor and actuator network located at the second node 20 perform a method of controlling an actuator. The first physical sensor 110 has a first state 111 based on data sensed by the first physical sensor 110. The first physical sensor 110 may be any one of: a metering device in a node, a pollution sensor, a motion sensor, a humidity sensor, a light sensor, a temperature sensor, a visibility sensor, an image capturing sensor, a radar sensor, a sound sensor, a voice recorder, a CO2 sensor, a NOx sensor, a SOx sensor, a smoke sensor, a biological threat sensor, an infrared sensor, a thermal sensor, an antenna, e.g. an antenna for RF sensing, a vibration sensor.

In the embodiment of FIG. 1A, the sensor and actuator network also comprises a further actuator 420. The further actuator 420 is located at the first node 10. As generally achieved, control of the further actuator 420 may be done based on the first state 111 of the first physical sensor 110.

The first controller at the first node 10 is configured to define the first physical sensor 110 as a publisher so that the first state 111 is published in a sensor group 310. The publishing comprises transmitting the first state 111 from the first node 10 to at least said second node 20. The sensor group 310 may be considered as a type of logical construct which is replicated at the first node and at the at least second node 20. Information in the sensor group 310 is propagated in the nodes where the sensor group 310 exists, here at the first node 10 and at the second node 20. More particularly, in the embodiment of FIG. 1A, the first state 111 which is captured by the first physical sensor 110 is broadcasted at the first node 10 to be received, and optionally processed, at the second node 20 via the sensor group 310. The skilled person will understand that the publishing in the above is not limited to a broadcast-type of communication but could be implemented using other wired or wireless communication technologies between the first node and the at least second node without departing from the scope of the invention.

At the second node 20, the second controller may be configured to create a virtual sensor 210. The virtual sensor 210 has a state 211 and is associated to the sensor group 310. The virtual sensor 210 is defined as a subscriber to the sensor group 310 of the first physical sensor 110. That is, the virtual sensor 210 will receive the sensed data published in the sensor group 110 by the first physical sensor 110 and broadcasted between nodes, e.g. between the first node 10 and the at least second node 20. The state 211 of the virtual sensor 2100 will become the received sensed data, here the first state 111. So, the first physical sensor 110 at the first node will be effectively cloned at the at least second node 20.

Alternatively or additionally, a group state 311 of the sensor group 310 may be determined at least based on the first state 111. The sensor group 310 takes at least the first state 111 as an input to determine the group state 311 and a processing of this input may occur. The processing may take the form of an operation applied to the input. The output of the operation will be the group state 311. Alternatively, the operation may be defined as a separate logical construct, i.e. a data fusion construct, configured for performing data fusion based on at least the first state. The data fusion construct takes at least the first state published as an input, i.e. the first physical sensor publishes its first state to the data fusion construct. Then, the data fusion construct applies to one or more inputs the operation defining how the group state is determined. The data fusion construct is defined as a publisher in the sensor group; so, an output of the operation is published to the sensor group in order to obtain the group state of the sensor group.

Depending on embodiments, processing of the inputs, e.g. the first state 111, in the sensor and actuator network can take different shapes and processing architectures including, but not limited to, cloud computing, edge computing, fog computing, as explained above. Alternatively, in an embodiment, the processing may be performed only at the second node 20 where the actuator 410 is physically located and lessens the burden on the rest of the network. It is to be noted that the actuator and sensor network may comprise other nodes in addition to the first node 10 and the second node 20. According to another embodiment, the processing may be divided between the nodes in the network depending on a processing power of each node, e.g. with the amount of processing performed by each node being proportional to the processing power of said node. According to an alternative embodiment, the processing may be performed at another node part of the network different from the node where the actuator 410 is physically located, e.g. at the first node 10 or a further node.

Depending on embodiments, the group state 311 or the state 211 of the virtual sensor 210 will be used by the second controller to control the actuator 410. By controlling the actuator 410, it is meant modifying an actuation profile of the actuator 410. The actuation profile may include simply the switching of the actuator 410 between an off state and an on state, or may involve a more complex control with a modification of a frequency or an intensity of the actuation, for example, as well as other functioning parameters of the actuator 410. By actuator, it is meant a mechanism that supplies and transmits a measured amount of energy for the operation of another device or system. An actuator of the sensor and actuator network may be to supply and transmit energy to any one or more of the following devices: a lighting device, a display device, an antenna device, a sensor, a speaker device, an air cleaning device such as a UV light source, a water sprinkler, a power relay, a motorized device, a communication device.

In the embodiment of FIG. 1B, the sensor and actuator network comprises a first physical sensor 110, a second physical sensor 120, and an actuator 410. The first physical sensor 110 is located at the first node 10. The second physical sensor 120 and the actuator 410 are located at the second node 20. The first physical sensor 110 has a first state 111. A first controller located at the first node 10 may be configured to associate the first physical sensor 110 to a sensor group 310 as a publisher for publishing the first state 111. The second physical sensor 120 has a second state 121.

A second controller located at the second node 20 may be configured to associate the second physical sensor 120 to the sensor group 320 as a publisher for publishing the second state 121. The second controller may determine the group state 311 of the sensor group 310 based on the first state 111 and the second state 121. The group state 311 may be determined by performing one or more operations on the first state 111 and the second state 121. Operations on the states may be any one of the following or a combination thereof: a Boolean operation, an addition, a subtraction, a multiplication, a division, a maxima operation, a minima operation, a weighted operation, a conversion operation. In the embodiment of FIG. 1B, the group state 311 will be used by the second controller to control the actuator 410 at the second node 20.

In the embodiment of FIG. 1C, the sensor and actuator network comprises a first physical sensor 110, a second physical sensor 120, an actuator 410, and a further actuator 420. The first physical sensor 110 and the further actuator 420 are located at the first node 10. The second physical sensor 120 and the actuator 410 are located at the second node 20. The first physical sensor 110 has a first state 111. A first controller located at the first node 10 may be configured to associate the first physical sensor 110 to a sensor group 310 as a publisher for publishing the first state 111. The second physical sensor 120 has a second state 121. A second controller located at the second node 20 may be configured to associate the second physical sensor 120 to the sensor group 310 as a publisher for publishing the second state 121. At the second node 20, the second controller is configured to create a virtual sensor 210. The virtual sensor 210 has a state 211 and is associated to the sensor group 310. The virtual sensor 210 is defined as a subscriber to the sensor group 310 of the first physical sensor 110 and the state 211 will adopt the value of the first state 111 published in the sensor group 310. At the first node 10, the first controller is configured to create a further virtual sensor 220. The further virtual sensor 220 has a further state 221 and is associated to the sensor group 310. The further virtual sensor 220 is defined as a subscriber to the sensor group 310 of the second physical sensor 120 and the further state 221 will adopt the value of the second state 121 published in the sensor group 310. In the embodiment of FIG. 1C, the second state 121 will be used by the first controller to control the further actuator 420 at the first node 10, and the first state 111 will be used by the second controller to control the actuator 410 at the second node 20.

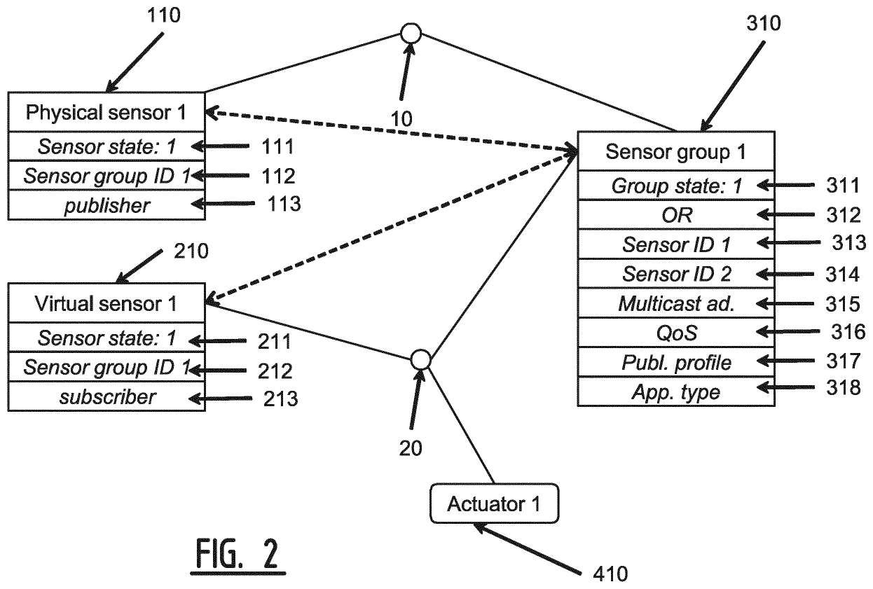

In the embodiment of FIG. 1D, the sensor and actuator network comprises a first physical sensor 110, a second physical sensor 120, an actuator 410, and a further actuator 420. The first physical sensor 110 and the further actuator 420 are located at the first node 10. The second physical sensor 120 and the actuator 410 are located at the second node 20. The first physical sensor 110 has a first state 111. A first controller located at the first node 10 may be configured to associate the first physical sensor 110 to a sensor group 310 as a publisher for publishing the first state 111. The second physical sensor 120 has a second state 121. A second controller located at the second node 20 may be configured to associate the second physical sensor 120 to the sensor group 310 as a publisher for publishing the second state 121, and to associate the second physical sensor 120 to a further sensor group 320 as a publisher for publishing the second state 121. At the first node 10, the first controller is configured to create a further virtual sensor 220. The further virtual sensor 220 has a further state 221 and is associated to the further sensor group 320. The further virtual sensor 220 is defined as a subscriber to the further sensor group 320 of the second physical sensor 120 and the further state 221 will adopt the value of the second state 121 published in the sensor group 310. In the embodiment of FIG. 1D, the group state 311 determined by the second controller based on the first state 111 and the second state 121 will be used by the second controller to control the actuator 410 at the second node 20, and the further state 121 will be used by the first controller to control the further actuator 420 at the first node 10. The sensor group 310 of FIG. 1D is defined by the following information: the group state 311, an operation 312, a first sensor identifier 313, and a second sensor identifier 314. The operation 312 is a Boolean operation, an OR operation, between the first state 111 and the second state 121. Indeed, these states are taken as inputs for the operation since the first physical sensor 110 and the second physical sensor 120 are referenced by their respective sensor identifiers 313, 314, e.g. memory pointers, in the information defining the sensor group 310. A more detailed description on the information defining sensor group, virtual sensors, and physical sensors will follow with reference to FIG. 2.

In the embodiment of FIG. 1E, the sensor and actuator network comprises a first physical sensor 110, a second physical sensor 120, a third physical sensor 130, and a further actuator, here a second actuator 420. The first physical sensor 110 and the second actuator 420 are located at the first node 10. The second physical sensor 120 is located at the second node 20. The third physical sensor 130 is located at a third node 30. The first physical sensor 110 has a first state 111. A first controller located at the first node 10 may be configured to associate the first physical sensor 110 to a sensor group, here a first sensor group 310, as a publisher for publishing the first state 111. The second physical sensor 120 has a second state 121. A second controller located at the second node 20 may be configured to associate the second physical sensor 120 to the first sensor group 310 as a publisher for publishing the second state 121. A third controller located at the third node 30 may be configured to associate the third physical sensor 130 to a further group, here a second sensor group 320, as a publisher for publishing a third state 131 of the third physical sensor 130. At the first node 10, the first controller is configured to determine a group state 311 of the first sensor group 310 based on the first state 111 and the second state 121. Indeed, the group state 311 is determined using an OR operation 312 on the states published by the first physical sensor 110 identified by a first sensor identifier 313 and by the second physical sensor 120 identified by a second sensor identifier 314. At the first node 10, the first controller is further configured to determine a further group state 321 of the second sensor group 320 based on the third state 131 and the group state 311. Indeed, the further group state 321 is determined using an AND operation 322 on the state published by the third physical sensor 130 identified by a further first sensor identifier 323, and on the state determined by the sensor group 310 identified by a further second sensor group identifier 324. In the embodiment of FIG. 1E, the further group state 321 will be used by the first controller to control the second actuator 420 at the first node 10.

FIG. 2 is a more detailed illustration of an exemplary embodiment of a sensor and actuator network according to the present invention.

The sensor and actuator network comprises a first physical sensor 110. The first physical sensor 110 is located at a first node 10. A first controller part of the sensor and actuator network at the first node 10 is configured to define the first physical sensor 110 as a publisher so that a first state 111 of the first physical sensor 110 is published in a sensor group 310. The first state 111 of the first physical sensor 110 is based on data sensed by the first physical sensor 110. The publishing comprises transmitting the first state 111 from the first node 10 to at least a second node 20.

The sensor and actuator network also comprises an actuator 410. The actuator is located at the second node 20.

At the second node 20, a second controller part of the sensor and actuator network is configured to create a virtual sensor 210. The virtual sensor 210 has a state 211 and is associated to the sensor group 310. The virtual sensor 210 is defined as a subscriber to the sensor group 310 of the first physical sensor 110.

The first node 10, the second node 20, and any other node with a physical sensor and/or virtual sensor and/or actuator associated to the sensor group 310 may store information related to the sensor group 310, said information comprising a group state 311. The group state 311, in the embodiment of FIG. 2, is determined based at least on the first state 111.

In the embodiment of FIG. 2, the information defining the sensor group 310 comprises a multi-cast address 315 linked to the first physical sensor 110 and any other physical sensor and/or virtual sensor and/or actuator associated to the sensor group 310. Using the multicast address 315, unwanted communication may be prevented and clogging in the sensor and actuator network may be avoided. Additionally, scalability of the network is improved when adding physical sensors and/or actuators since association to the sensor group 310 may be performed by pointing the added physical sensors and/or actuators to the multicast address 315.

Further, the information in FIG. 2 defining the sensor group 310 comprises an operation 312, here an OR operation, defining how the group state 311 is determined based on at least the first state 111. Preferably, the operation is any one of the following or a combination thereof: a Boolean operation, an addition, a subtraction, a multiplication, a division, a maxima operation, a minima operation, a weighted operation, a conversion operation. Also, the information may comprise the first state 111 and a state for any other physical sensor and/or virtual sensor associated to the sensor group 310.

Additionally, the information defining the sensor group 310 comprises in the embodiment of FIG. 2 the following information: a sensor group identifier (not shown), an application type 318 defining a type of service provided by the sensor group 310, a quality of service (QOS) 316 defining transmission and/or congestion related information, a publisher communication profile 317 defining information related to the publishing by the first physical sensor 110 and any other sensor associated to the sensor group 310 as a publisher, a sensor identifier 313, 314.

In the embodiment of FIG. 2, the first sensor identifier 313 is a reference to a sensor identifier of the first physical sensor 110; the second sensor identifier 314 does not contain any data. The sensor group identifier may be used as a reference for the first physical sensor 110 and/or the virtual sensor 210 to establish the link between them and the sensor group 310. The application type 318 may be used to define a role or type of information which is outputted as the group state 311. The quality of service 316 may be used to prioritize information coming from higher rated communication sources and enable a more efficient use of the sensor and actuator network. The publisher communication profile 317 may be used to define communication parameters of sensors associated to the sensor group as publishers. The communication parameters which are definable may comprise any one of: a distance counter, a publishing criteria, a minimum publishing frequency, a maximum publishing frequency, a publisher step interval. The communication parameters may apply to all publishers associated to the sensor group 310.

The group state 310 may be defined by the information in the following table:

| Name | Description |
|---|---|
| Group state | The current output state of the sensor group, derived either |
| | from the latest sensor state published to the sensor group or |
| | computed based on all sensor inputs and the data fusion |
| | operation used. |
| Multicast address | The multicast address used by publishers and subscribers to |
| | the sensor group. |
| Quality of Service (QoS) | If the underlying transport technology supports QoS, this |
| | resource can be used to set the buffering and forwarding |
| | priority of the group state within the network. |
| Distance counter | Used by publishers to set a node hop limit on the |
| | communications broadcasted to forward sensor states, in |
| | this way limiting the reach of the forwarding. |
| Publishing criteria | 1 - on change of the sensor state; or |
| | 2 - periodically; or |
| | 3 - both |
| Minimum publishing | Used by publishers, this parameter limits the rate at which a |
| frequency | sensor is allowed to publish to the sensor group. This is |
| | used to avoid message storming scenarios within the sensor |
| | group. |
| Maximum publishing | Used by publishers, this parameter should be used when the |
| frequency | “Publishing criteria” is set to either 2 or 3, defining the |
| | maximum amount of time that can elapse before a sensor |
| | publishes its current state within the sensor group (default: |
| | 1 hour). |
| Publisher step interval | Used by publishers, this parameter works as a filter, |
| | allowing only significant variations in the value of the |
| | sensor step (i.e. a minimum step interval) before the state is |
| | published to the sensor group (default: 1). |
| Sensor identifier | There can be multiple instances of sensor identifiers which |
| | can each store a sensor identifier of a publisher. |
| Fusion operation | Used to perform operations between the sensor states of the |
| | sensors referenced by the “Sensor identifier(s)”. |
| | 0 - Custom operation |
| | 1 - OR |
| | 2 - AND |
| | 3 - ADD |
| | 4 - MAX |
| | 5 - MIN |
| Application type | Identifies the type of application of the sensor group. |
| Group Member | Multiple instance resource which may be used to identify |
| | sensor objects associated with the group. The state of each |
| | “Group Member” is used as an input to the sensor group |
| | “data fusion operation”. |
| Member Role | Defines the role of the sensor object within the sensor |
| | group |
| | 0 - detached: the sensor may be connected to the sensor |
| | group but is not processing information to or from the |
| | group |
| | 1 - publisher: the sensor state is published to the sensor |
| | group |
| | 2 - subscriber: the sensor state is computed from the |
| | information provided from the sensor group |
| | 3 - publisher & subscriber |
| Member mapping | Defines how a sensor reading obtained from distributed |
| | sensors in the sensor group should be mapped to the virtual |
| | sensor equivalent residing on the node |
| | 0 - ANY: all sensor instances advertised within the group |
| | are mapped to the same “subscriber” virtual sensor object |
| | (this is usually used when only one subscriber group |
| | member is configured) |
| | 1 - One to one: only sensor readings with the same instance |
| | ID as the equivalent virtual sensor object defined under |
| | “group member” are mapped |
| | 2 - 9999: represents the instance ID number of sensor |
| | events published in the sensor group that should be mapped |
| | to the virtual sensor instance defined in “Group Member - 1”. |
| | When “Member mapping” is not defined, it is assumed to |
| | have a value of “0” if only one subscriber member is |
| | defined under the sensor group, and “1” is multiple |
| | subscriber members are defined within the group. |

In the embodiment of FIG. 2, the first physical sensor 110 is defined at the first node by storing the following information: the first state 111, a sensor identifier (not shown), a sensor group role 113 indicating that the first physical sensor 110 is a publisher, a sensor group identifier 112 of the sensor group 310. The sensor identifier may be used as a reference for the first physical sensor 110 to establish the link between it and the sensor group 310 to be used as an input, and/or as a reference for the virtual sensor 210 as a subscriber of the first physical sensor 110.

The sensor group role 113 may be used to determine the relationship of the first physical sensor 110 with the sensor group 310 in terms of communication transmission and reception. A sensor may be any one of: publisher, subscriber, and detached. A publisher is configured for publishing the state of a sensor in the sensor group, which will be then broadcasted in the nodes where the sensor group exists. A subscriber is configured for receiving as its state a state of a sensor it is subscribed to, via the sensor group. A detached sensor is a sensor whose transmitted data has been deemed as untruthful, e.g. due to a malfunction, and whose transmission to the sensor group is blocked temporarily.

The sensor group identifier 112 may be used in the information of the first physical sensor 110 as a reference to the sensor group 310 it is associated to. It is to be noted that a physical sensor may be associated to a plurality of sensor groups and publish its state to each of the plurality of sensor groups. As such, the first physical sensor 110 may also be defined by a further sensor group identifier of a further sensor group associated to the first physical sensor 110.

Similarly as the first physical sensor 110, the virtual sensor 210 in the embodiment of FIG. 2 is defined at the second node by storing the following information: the state 211, a sensor identifier (not shown), a sensor group role 213 indicating that the virtual sensor 210 is a subscriber, a sensor group identifier 212 of the sensor group 310.

In an alternative embodiment, and as can be seen in the table above, the sensor group role indicating that the first physical sensor is a publisher may be available in the information of the sensor group instead of the information of the first physical sensor. Similarly, in an alternative embodiment, the sensor group role associated with the virtual sensor may be available in the information of the sensor group instead of the information of the virtual sensor.

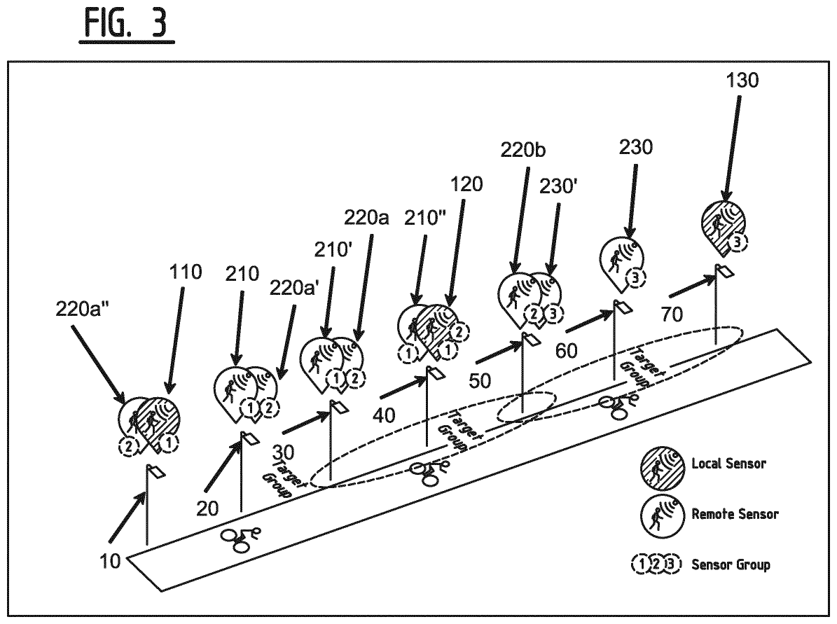

FIG. 3 depicts an exemplary embodiment of a sensor and actuator network included in a luminaire network according to the present invention.

In the embodiment of FIG. 3, a sensor and actuator network is included in a luminaire network, preferably an outdoor luminaire network. The luminaire network may be a mesh network.

The luminaire network comprises a plurality of luminaires positioned along a bicycle path. Additionally, each node of a plurality of nodes 10, 20, 30, 40, 50, 60, 70 of the luminaire network is located at a luminaire of the luminaire network.

The luminaire network in the embodiment of FIG. 3 comprises a first physical sensor 110 located at a first node 10, a second physical sensor 120 located at a fourth node 40, and a third physical sensor 130 located at a seventh node 70. The first physical sensor 110 and the second physical sensor 120 are associated to a first sensor group. To the first sensor group are also associated the following: a first virtual sensor 210 created at a second node 20, a second virtual sensor 210′ created at a third node 30, a third virtual sensor 210″ created at the fourth node 40. The second physical sensor 120 is further associated to a second sensor group. To the second sensor group are also associated the following: a fourth virtual sensor 220a created at the third node 30, a fifth virtual sensor 220a′ created at the second node 20, a sixth virtual sensor 220a″ created at the first node 10, a seventh virtual sensor 220b created at a fifth node 50. The third physical sensor 130 is associated to a third sensor group. To the third sensor group are also associated the following: an eight virtual sensor 230 created at a sixth node 60, a ninth virtual sensor 230′ created at the fifth node 50.

The first, second, and third physical sensor 110, 120, 130 are presence sensors in the embodiment of FIG. 3. Each of the physical sensors 110, 120, 130 are defined as publishers in their respective sensor groups. Each of the plurality of virtual sensors 210, 210′, 210″, 220a, 220a″, 220a″, 220b, 230, 230′ are defined as subscribers in their respective sensor groups. States of each of the plurality of virtual sensors 210, 210′, 210″, 220a, 220a′, 220a″, 220b, 230, 230′ may be used to control a switching of a lighting device of the luminaire network at the respective node where virtual sensors are located. Additionally or alternatively, other optical parameters of the lighting device may be altered such as intensity, light distribution, light temperature, light colour.

In doing so, a bicycle passing on the bicycle lane and being detected by the first physical sensor 110, for example, can trigger the switching of lighting devices not only at the first node 10, but also at the second, third, and fourth nodes 20-40 where the virtual sensors 210, 210′, 210″ of the first sensor group are also located. Continuing on its way along the bicycle lane, when detected by the second physical sensor 120 also associated to the first sensor group, the bicycle can trigger the dimming of lighting devices at the first, second, third, and fourth nodes 10-40, while, via the virtual sensors 220a, 220a′, 220a″, 220b associated to the second sensor group, additional controlling of lighting devices at the first to fifth nodes 10-50 is performed.

Whilst the principles of the invention have been set out above in connection with specific embodiments, it is to be understood that this description is merely made by way of example and not as a limitation of the scope of protection which is determined by the appended claims.

1. A method of controlling an actuator in a sensor and actuator network comprising a first physical sensor at a first node and an actuator at a second node, comprising:
associating at least the first physical sensor to a sensor group;
defining the first physical sensor as a publisher for publishing a first state of the first physical sensor in the sensor group, said first state being based on data sensed by the first physical sensor, said publishing comprising transmitting said first state from said first node to at least said second node; and
at least one of:
creating a virtual sensor having a state at the second node, associating the virtual sensor to the sensor group; defining the virtual sensor as a subscriber for receiving the first state as the state of the virtual sensor; and controlling the actuator based on the state of the virtual sensor; or
determining a group state of the sensor group at least based on the first state; and controlling the actuator based on the group state.

2. The method according to claim 1, wherein the sensor and actuator network further comprises a second physical sensor, and wherein the method further comprising:
associating the second physical sensor to the sensor group;
defining the second physical sensor as a publisher for publishing a second state of the second physical sensor in the sensor group, said second state being based on data sensed by the second physical sensor;
determining the group state of the sensor group based on the first state and the second state.

3. The method according to claim 1, wherein the first node, the second node, and any other node with a physical sensor and/or virtual sensor and/or actuator associated to the sensor group stores information related to the sensor group, said information comprising the group state.

4. The method of claim 3, wherein the information comprises a multi-cast address linked to the first physical sensor and any other physical sensor and/or virtual sensor and/or actuator associated to the sensor group.

5. The method according to claim 3, wherein the information comprises an operation defining how the group state is determined based on at least the first state.

6. The method according to claim 5, wherein the operation is any one of the following or a combination thereof: a Boolean operation, an addition, a subtraction, a multiplication, a division, a maxima operation, a minima operation, a weighted operation, or a conversion operation.

7. The method according to claim 3, wherein the information comprises the first state and a state for any other physical sensor and/or virtual sensor associated to the sensor group.

8. The method according to claim 3, wherein the information comprises any one or more of the following information: a sensor group identifier, an application type defining a type of service provided by the sensor group, a quality of service defining transmission and/or congestion related information, or a publisher communication profile defining information related to the publishing by the first physical sensor and any other sensor associated to the sensor group as a publisher.

9. The method according to claim 1, wherein the first physical sensor is defined at the first node by storing the following information: the first state, a sensor identifier, a sensor group identifier of the sensor group, and optionally a further sensor group identifier of a further sensor group associated to the first physical sensor.

10. The method according to claim 2, wherein the second physical sensor is of the same type as the first physical sensor.

11. The method according to claim 1,
wherein the method further comprises:
associating the first physical sensor to a further sensor group;
defining the first physical sensor as a publisher for publishing the first state in the further sensor group; and
determining a further group state of the further sensor group at least based on the first state.

12. The method according to claim 11, wherein the sensor and actuator network further comprises a further actuator, and wherein the method further comprises at least one of:
creating a further virtual sensor having a further state, associating the further virtual sensor to the further sensor group; defining the further virtual sensor as a subscriber for receiving the first state as the further state of the further virtual sensor; and controlling the further actuator based on the further state of the further virtual sensor; or
controlling the further actuator based on the further group state.

13. The method according to claim 1, wherein the sensor and actuator network is included in a luminaire network, preferably an outdoor luminaire network.

14. The method according to claim 13, wherein the first node is located at a first luminaire of the luminaire network and the second node is located at a second luminaire of the luminaire network.

15. The method according to claim 1, wherein the sensor and actuator network is a mesh network.

16. (canceled)

17. (canceled)

18. (canceled)

19. (canceled)

20. (canceled)

21. A controller for use in a sensor and actuator network, said controller being configured:
to define a sensor group associated with one or more physical and/or virtual sensors located in one or more nodes of the sensor and actuator network;
to define a first physical sensor of said one or more physical and/or virtual sensors as a publisher so that a first state thereof is published in the sensor group, said publishing comprising transmitting said first state from a node where the first physical sensor is located to any other node associated to the sensor group, said first state being based on data sensed by the first physical sensor; and
to determine a group state of the sensor group at least based on the first state.

22. The controller of claim 21, wherein the controller is further configured: to create a virtual sensor having a state, associating the virtual sensor to the sensor group; to define the virtual sensor as a subscriber so that the first state is set as the state of the virtual sensor; and to control an actuator based on the state of the virtual sensor.

23. The controller according to claim 21, wherein the controller is further configured to control an actuator based on the group state.

24. A luminaire controller for a sensor and actuator network according to claim 21.

25. A method of controlling an actuator in a sensor and actuator network comprising a first physical sensor at a first node and an actuator at a second node, comprising:
associating at least the first physical sensor to a sensor group;
defining the first physical sensor as a publisher for publishing a first state of the first physical sensor in the sensor group, said first state being based on data sensed by the first physical sensor, said publishing comprising transmitting said first state from said first node to at least said second node; and
at least one of:
creating a virtual sensor having a state at the second node, associating the virtual sensor to the sensor group; defining the virtual sensor as a subscriber for receiving the first state as the state of the virtual sensor, wherein the state of the virtual sensor is processed by a processor at the second node; and controlling the actuator based on the processed state of the virtual sensor; or
determining a group state of the sensor group at least based on the first state, wherein the group state is determined by a processor at the second node; and controlling the actuator based on the group state.
